(19) United States
(12) Patent Application Publication
(10) Pub. No.: US 2026/0104994 A1
(43) Pub. Date: Apr. 16, 2026

(54) MEMORY DEVICE PRECONDITIONING

(71) Applicant: SK Hynix NAND Product Solutions Corp. (dba Solidigm), Rancho Cordova, CA (US)

(72) Inventors: Niranjan Patankar, Folsom, CA (US); Anilmurali Bhaviri, Longmont, CO (US); Jonathan Wacker, Folsom, CA (US); Mark Anthony Golez, Folsom, CA (US); Harsh Singh, Broomfield, CO (US)

(21) Appl. No.: 18/912,376

(22) Filed: Oct. 10, 2024

(51) Int. Cl. G06F 12/02

(52) U.S. Cl. CPC G06F 12/0246; G06F 2212/7201

(57) ABSTRACT

A method for configuring a memory device includes reading, using a host device, data generated based on memory of a reference memory device, wherein the reference memory device is preconditioned for the performance evaluations, generating a NAND map of the memory based on the reading, wherein the NAND map includes a logical-to-physical address mapping of the memory, and data indicative of invalid physical addresses of the memory, and causing the NAND map to be written to the memory device. In some embodiments, the NAND map includes physical-to-logical address mapping data indicative of valid physical addresses of the logical-to-physical address mapping, and the invalid physical addresses.

### TECHNICAL FIELD

The present disclosure is directed to methods and systems for configuring a memory device to be preconditioned for, for example, performance evaluations, functional testing, or both.

### BACKGROUND

Memory devices may need to be configured before conducting performance evaluations or functional testing on the memory devices. Various configuration approaches can influence the throughput of the evaluations or testing.

### SUMMARY

In accordance with some embodiments of the present disclosure, a method for configuring a memory device includes reading, using a host device, data generated based on memory of a reference memory device, where the reference memory device is preconditioned for the performance evaluations. The method also includes generating a NAND map of the memory based on the reading, where the NAND map includes a logical-to-physical address mapping of the memory, and data indicative of invalid physical addresses of the memory. The method also includes causing the NAND map to be written to the memory.

In some embodiments, the NAND map includes physical-to-logical address mapping data indicative of valid physical addresses of the logical-to-physical address mapping, and the invalid physical addresses.

In some embodiments, causing the NAND map to be written includes causing firmware of the memory device to write the NAND map, where causing the firmware of the memory device to write the NAND map includes creating invalid location addresses by writing invalid placeholder data to at least a portion of the invalid physical addresses, and, after writing to at least the portion of the invalid physical addresses, creating valid location addresses by writing valid placeholder data to at least a portion of the valid location addresses.

In some embodiments, causing the NAND map to be written includes issuing a plurality of write commands without transferring the invalid placeholder data or the valid placeholder data.

In some embodiments, the method also includes causing firmware of the memory device to randomly generate data for the invalid placeholder data and for the valid placeholder data.

In some embodiments, the method also includes reading additional information of the memory, the additional information including at least one of: memory component temperatures or memory metadata.

In some embodiments, the memory metadata includes at least one of an erase cycle count, a read disturb count, or a program count, or a time since a memory location was last programmed.

In some embodiments, the method also includes, after causing the NAND map to be written to the memory, causing the additional information to be written to the memory.

In accordance with some embodiments of the present disclosure, a system includes a host device communicatively coupled to a memory device. The host device is to read data generated based on memory of a reference memory device, where the reference memory device is preconditioned for performance evaluations. The host device is also to generate a NAND map of the memory based on the read, where the NAND map includes a logical-to-physical address mapping of the memory, and data indicative of invalid physical addresses of the memory. The host device is also to cause the NAND map to be written to the memory device.

In some embodiments, the NAND map includes physical-to-logical address mapping data indicative of valid location addresses of the logical-to-physical address mapping table and the invalid physical addresses.

In some embodiments, to cause the NAND map to be written causing firmware of the memory device to write the NAND map, wherein causing the firmware of the memory device to write the NAND map includes creating invalid location addresses by writing invalid placeholder data to at least a portion of the invalid physical addresses, and after writing to at least the portion of the invalid physical addresses, creating valid location addresses by writing valid placeholder data to at least a portion of the valid location addresses.

In some embodiments, to cause the NAND map to be written includes issuing a plurality of write commands without transferring the invalid placeholder data or the valid placeholder data.

In some embodiments, the host device is also to cause firmware of the memory device to randomly generate the invalid placeholder data and the valid placeholder data.

In some embodiments, the host device is also to read additional information of the memory, the additional information including at least one of: memory component temperatures or memory metadata.

In some embodiments, the memory metadata includes at least one of an erase cycle count, a read disturb count, a program count, or a time since a memory location was last programmed.

In some embodiments, the host device is also to, after causing the NAND map to be written to the memory, cause the additional information to be written to the memory.

In accordance with some embodiments of the present disclosure, a data structure for configuring memory of a memory device includes a logical-to-physical address mapping including valid physical addresses of the memory, where valid memory is stored at the valid physical addresses, data indicative of invalid physical addresses of the memory, where invalid memory is stored at the invalid physical addresses, and physical-to-logical address mapping data indicative of the valid physical addresses and the invalid physical addresses.

In some embodiments, the data structure also includes memory component temperatures of the memory device.

In some embodiments, the data structure also includes memory metadata of the memory device.

In some embodiments, the memory metadata includes at least one of an erase cycle count, a read disturb count, a program count, or a time since a memory location was last programmed.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows representative preconditioning times;

FIG. 2 shows a storage device and a host configured to precondition the device, in accordance with some embodiments of the present disclosure;

FIG. 3 shows a diagram of an illustrative flow for generating a clone image of a memory drive, in accordance with some embodiments of the present disclosure;

FIG. 4 shows a NAND map, in accordance with some embodiments of the present disclosure;

FIG. 5 shows a diagram of an illustrative flow for writing a clone image to a memory drive, in accordance with some embodiments of the present disclosure;

FIG. 6 shows a flowchart of illustrative steps for writing a clone image to a memory drive, in accordance with some embodiments of the present disclosure; and

FIG. 7 shows a flowchart of illustrative steps for memory device preconditioning, in accordance with some embodiments of the present disclosure.

### DETAILED DESCRIPTION

Performance metrics associated with a memory device (e.g., with a solid-state drive (SSD), including those operating under the nonvolatile memory express (NVMe) protocol) include inputs/outputs per second (IOpS), latency, and stability (e.g., an amount of deviation from a typical bandwidth of operations). These performance metrics are affected by background input/output (IO) operations.

Some illustrative background IO operations include operations related to garbage collection (e.g., rewriting memory to correct for invalid logical block addresses (LBAs), or for any other suitable purpose), wear leveling (e.g., rearranging data to maintain various memory bands at comparable array cycle counts), read disturb processes (e.g., moving data in response to skewed voltage levels at memory cells), or background data refreshing (e.g., monitoring and modifying, as needed, written sections of memory to cause the written sections to have a relatively uniform age). These background operations are implemented to extend the lifetime and maintain the operational reliability of memory devices.

The execution of these background IO operations depends on the configuration of a memory device (e.g., how data is distributed on the device, how NAND cells are used on the device, and how much power is available to the device). Thus, normalizing performance evaluations on a memory device may require configuring the memory device to a particular state (i.e., preconditioning the memory device) before executing performance evaluation tests.

As used herein, preconditioning may refer to any process that configures a memory device for evaluations (e.g., for performance evaluations or functional testing), and this disclosure may be applied in connection with any preconditioning operation. Some types of preconditioning may include running a preconditioning workload (e.g., to configure a device for generating target background IOs). In some embodiments, the preconditioning workload may include running a sequential write workload to write data to an entire memory drive, followed by a series of random write workloads to randomize the data patterning and the statuses (i.e., as valid or invalid) of the respective portions of the data. In some embodiments, a targeted workload may be run on the preconditioned device to execute the performance evaluations and/or the functional testing based on the preconditioned state which, in connection with the targeted workload, generates the target background IOs.

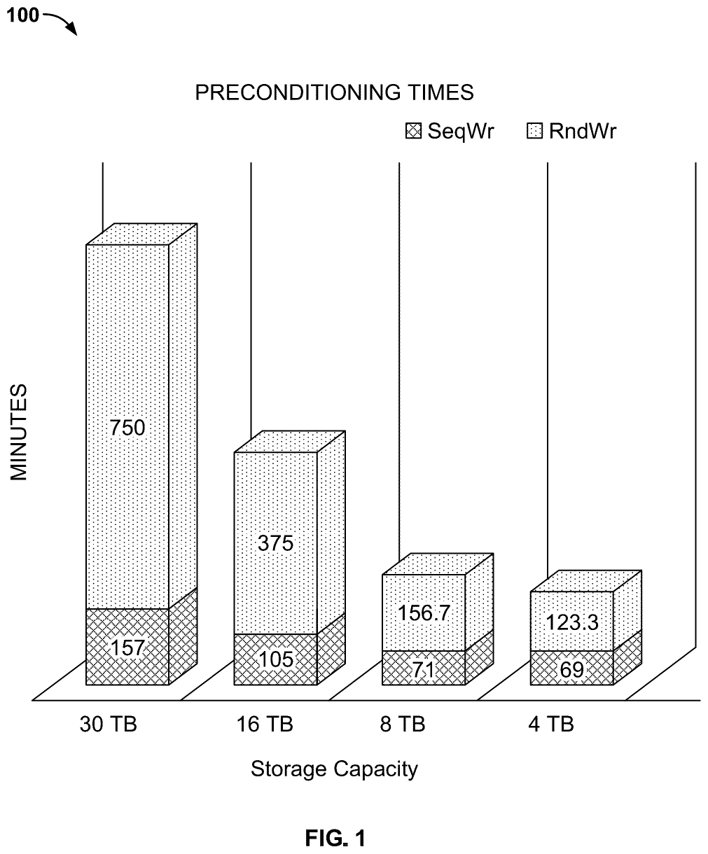

Preconditioning the memory device can be a slow process. For example, FIG. 1 shows illustrative times associated with a typical approach for preconditioning memory devices, based on the storage capacity of the memory device. As shown, it can take hundreds of minutes to run a single process for preconditioning a memory device; moreover, certain protocols may include running these respective processes multiple times (e.g., a typical approach may take over a thousand minutes to fully precondition a memory device). In some embodiments, preconditioning the drive requires one or more sequential writes (“SeqWr”, as depicted by the bottom portions of the respective columns of FIG. 1) followed by one or more random writes (“RndWr”, as depicted by the top portions of the respective columns of FIG. 1).

Similarly, functional testing of a memory device (e.g., investigating interactions between various write procedures and installed firmware policies) may depend on a state of the memory device. Thus, the memory device may be preconditioned to a desired state in order to properly execute functional testing.

Therefore, preconditioning may occur as part of the development, testing, and/or use of memory devices. Accordingly, device development, testing, and use may be hindered by slow speeds that are associated with typical approaches for preconditioning.

In accordance with embodiments of the present disclosure, systems and methods are provided for memory device preconditioning. For example, systems and methods of the present disclosure may reduce the sequential write times (e.g., compared to the illustrative times shown in FIG. 1) associated with typical memory device preconditioning. Based on this approach for memory device preconditioning, memory device performance may be evaluated more rapidly than can be achieved with other approaches.

In some embodiments of the present disclosure, a three-phase process is implemented (e.g., on a memory device by a host device) for memory device preconditioning. In the first phase, data is collected on a memory array to determine valid and invalid LBAs associated with the array. In the second phase, a clone image is generated for the memory array. The clone image may include stitching all the valid and invalid LBAs into a NAND map (e.g., a data structure listing all LBAs, along with whether each respective LBA stores valid or invalid data). In the third phase, the NAND map is written to a memory array. After the NAND map is written to the memory array, the corresponding memory device is configured or preconditioned for performance evaluations.

In some embodiments, it is desired to evaluate the performance of a target device that is operating in the field. Systems and methods of this disclosure may be implemented to more rapidly evaluate the performance of the target device without needing to physical access it. For example, the first phase may include preconditioning that target device and collecting data from the corresponding preconditioned memory array. That data can be used in the second phase for generating the clone image. Then, the third phase may include writing the clone image and the NAND map to a new memory device. Accordingly, it would be possible to evaluate the target device by running performance evaluations on the new memory device.

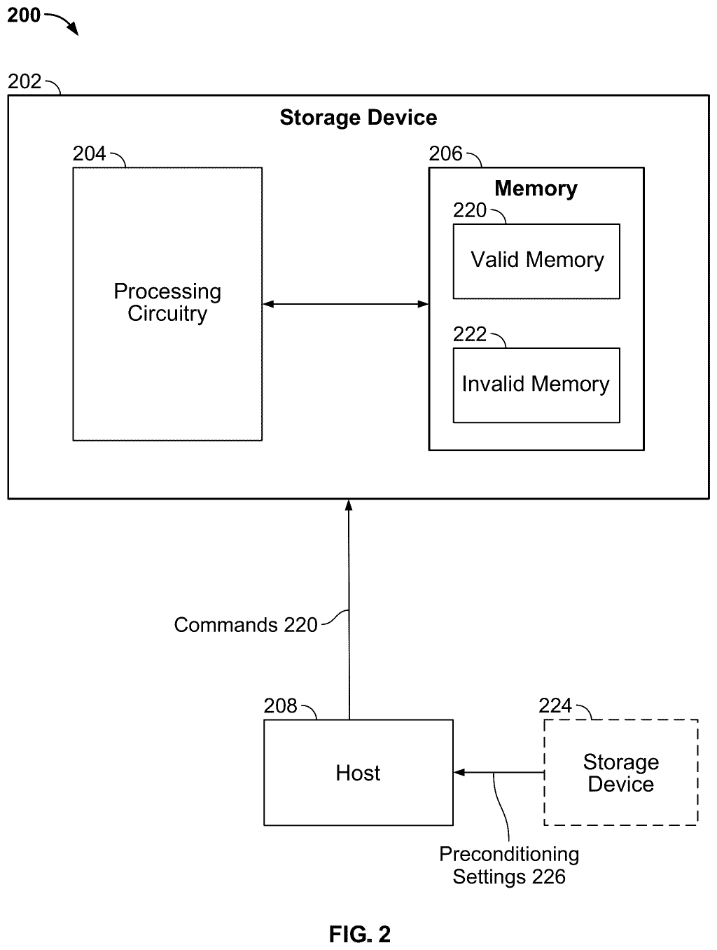

The subject matter of this disclosure is further discussed with reference to FIGS. 2-7.

FIG. 2 shows a storage device that is communicatively coupled to a host configured to cause the device to update, in accordance with some embodiments of the present disclosure. The storage device 202 includes processing circuitry 204 and memory 206. The memory 206 includes valid memory 220 (e.g., LBAs storing valid data) and invalid memory 222 (e.g., LBAs storing invalid data). Though they are depicted in FIG. 2 as separate entities, memory cells storing valid memory 220 may be physically adjacent to memory cells storing invalid memory 222. For example, memory 206 may include an array of memory cells in which portions of invalid memory 222 are interspersed between portions of valid memory 220.

Processing circuitry 204 can at least write to, read from, and erase from, memory cells of memory 206. The host 208 can cause processing circuitry 204 to perform these actions on memory 206 based on commands 220.

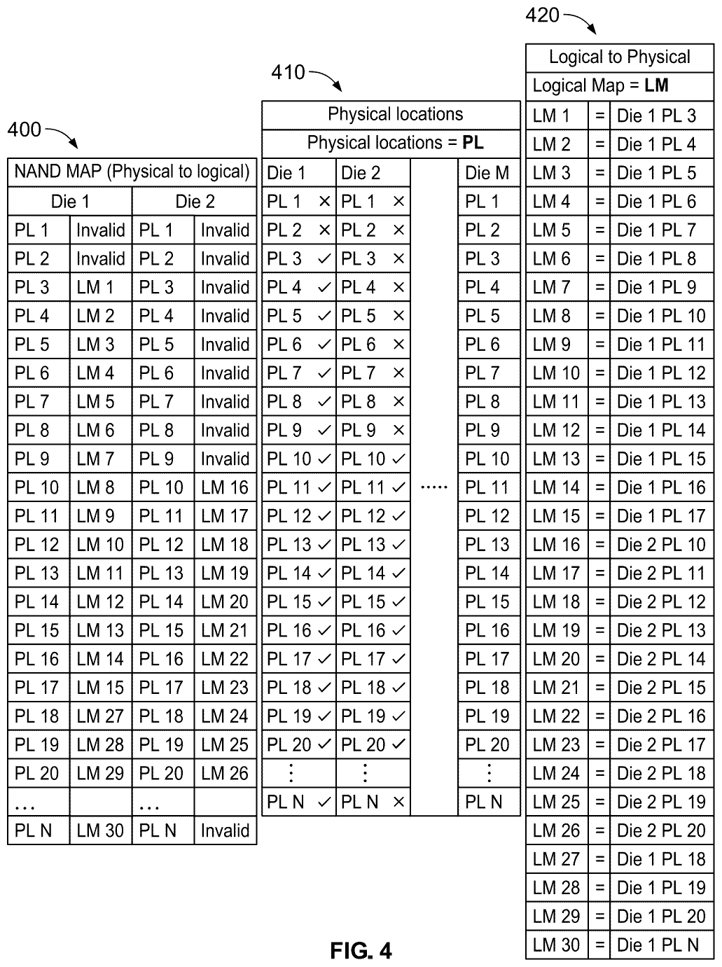

In some embodiments, host 208 may be coupled (e.g., through any suitable communication link) to storage device 224 (e.g., a reference memory device). Host 208 may be coupled to storage device 202 and storage device 224 at the same time, or host 208 may couple to (e.g., read data from and/or send commands to) each of these respective storage devices (directly or indirectly) at different times. Storage device 224 may be the same model as storage device 202, or it may otherwise have memory that can be configured identically to memory 206. Storage device 224 may include a memory array that is preconditioned for performance evaluations. As a result, based on reading data generated based on that memory array (or, optionally, based on directly reading that memory array), host 208 may receive or otherwise determine preconditioning settings 226. For example, the preconditioning settings 226 may include, or may be used to generate, the NAND map (as described above, in connection with FIG. 4, and elsewhere).

With reference to the aforementioned three-phase process for memory device preconditioning: the first phase may include host 208 collecting data from preconditioned storage device 224; the second phase may include host 208 configuring a NAND map (e.g., NAND map 400) based on the collected data (e.g., including preconditioning settings 226); and the third phase may include host 208 issuing write commands 220 that cause memory 206 of storage device 202 to be preconditioned (e.g., to reproduce the preconditioned state of storage device 224 at the first phase).

In some embodiments, storage device 202 (and storage device 224) is an SSD and the commands 220 cause the SSD to be preconditioned or configured for performance evaluations. The SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency. In some embodiments, SSDs use indirect memory addressing, which stores data into a next available physical memory address and maps the next available physical memory address to the logical memory address within an indirection table. In some embodiments, data structures are provided for additionally mapping (e.g., in a linked list, or through at least one parent node pointing to multiple child nodes) the addresses of stored data (e.g., allocated memory blocks), such that the stored data may be persisted by the SSD through a firmware update or other update to the SSD.

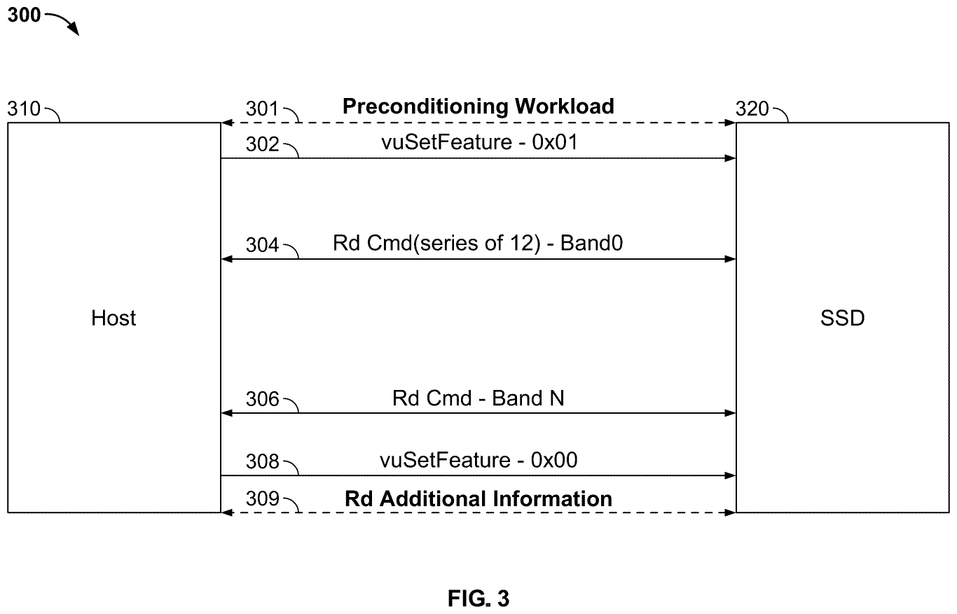

FIG. 3 shows an approach for generating a clone image of a memory drive, in accordance with some embodiments of the present disclosure. In some embodiments, host 310 and SSD 320 respectively correspond to host 208 and storage device 224. Operations 301, 302, 304, 306, 308, and 309 may be included within commands 220. With reference to the three-phase process described above for memory device preconditioning, the operations of FIG. 3 may correspond to the first phase.

In some embodiments, the operations of FIG. 3 begin with the optional step at 301 to run a preconditioning workload on SSD 320, which may be a first SSD. The preconditioning workload may configure the SSD 320 for properly providing the data at steps 304 and 306.

Based on the data provided at steps 304 and 306, a clone image (e.g., including NAND map 400) of SSD 320 may be written onto a second SSD (e.g., SSD 520). Because writing the NAND map to the second SSD constitutes preconditioning that SSD for performance evaluations or functional testing, it may be necessary to generate the clone image from a preconditioned SSD. That is, SSD 320 may be preconditioned (e.g., by host 310 at step 301, or by any other host device, using any suitable approach) to provide data for memory device preconditioning.

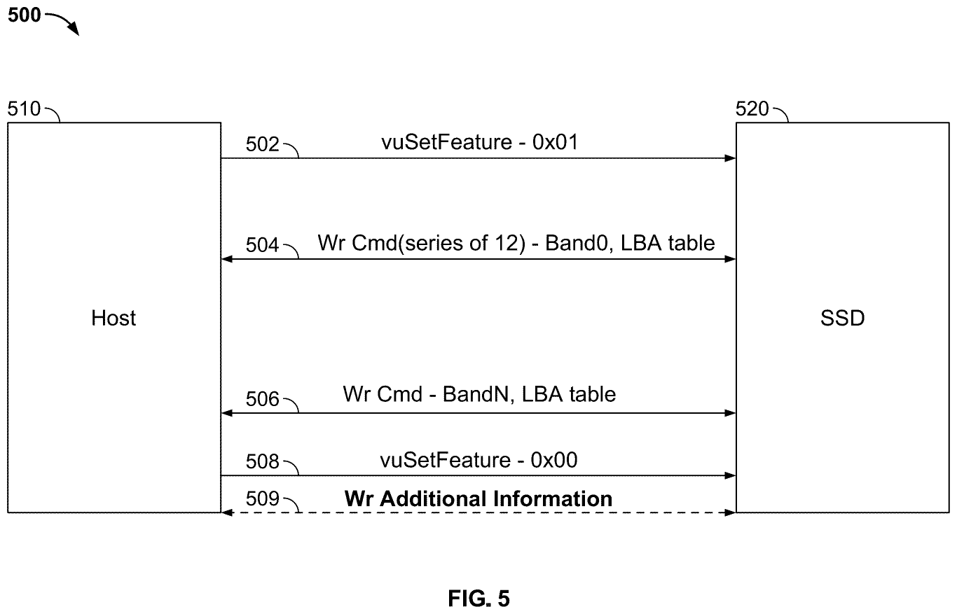

At step 302, host 310 issues a command to turn on the vuSetFeature (i.e., where 0x01 is an indicator to activate this feature). The command at step 302 instantiates the data collection process, which may also be referred to as cloning the memory array of SSD 320. As used in connection with at least FIGS. 3 and 5, the vuSetFeature is a command that causes a memory drive (e.g., SSD 320 or SSD 520) to enter or exit a state associated with particular read and write commands. For example, the read and write commands associated with the vuSetFeature may support the reading of validity/invalidity statuses of physical addresses, as well as the reading of NAND properties that are needed to generate the clone image (e.g., including NAND map 400). The read and write commands associated with the vuSetFeature may also support the writing of the clone image (e.g., including the stitched NAND map 400) to the target memory device.

At step 304, the host 310 issues a series of read commands (i.e., “Rd Cmd”) for an initial band (i.e., “Band0”) of the SSD 320. This series of read commands may include 12 commands, as shown, or any other suitable number of commands (e.g., based on a number of bands). Thus, SSD 320 generates an LBA sequence based on the configuration of memory on the SSD, and provides this LBA sequence (e.g., as a table) to host 310. This LBA sequence table includes LBAs storing valid data (e.g., as would be obtained in a typical logical-to-physical mapping) and LBAs storing invalid data (e.g., as would be omitted in a typical logical-to-physical mapping). For example, the LBA sequence table may include a portion of the list of physical locations 410 and a portion of the logical-to-physical mapping 420.

At step 306, host 310 repeats the operations at step 304 for all memory bands of SSD 320. That is, each respective series of read commands is repeated for each respective band, up to N bands, where N is the number of bands in the memory array of SSD 320. Thus, host 310 collects data corresponding to the entire memory array of SSD 320.

After completing the operations at steps 304 and 306, the host 310 may have retrieved a complete logical-to-physical address mapping table for SSD 320 (e.g., a list of valid memory locations, e.g., a complete logical-to-physical mapping 420) and a complete list of invalid LBA location addresses for SSD 320 (e.g., a list of invalid memory locations, e.g., as may be included within a complete list of physical locations 410). Thus, all data is available for generating a physical-to-logical address mapping table (e.g., NAND map 400, which may also be referred to as or include band metadata) for SSD 320.

At step 308, host 310 issues a command to turn off the vuSetFeature (i.e., where 0x00 is an indicator to deactivate this feature). The command at step 308 may complete the data collection process.

In some embodiments, FIG. 3 also includes the optional operation at step 309 where host 310 reads additional information from SSD 320. Despite being shown below step 308, the optional operations at step 309 may occur before the operation at step 308. The additional information may include SSD component temperatures, NAND metadata, or both. The SSD component temperatures, or memory component temperatures, may include temperatures of particular LBAs, NAND cells, or other circuitry of the memory device. The NAND metadata may include an erase cycle counter, a read disturb counter, a program counter, a time since the memory location was last programmed, or any combination thereof. In some embodiments, each of those respective types of NAND metadata may include a list of values, with each value of the list corresponding to a respective LBA (or a respective group of LBAs, e.g., where the group is based on a granularity of read, write, and/or erase operations).

After the operations of FIG. 3, any suitable host device (e.g., host device 208, host device 310, or host device 510) may generate the NAND map. As further shown in FIG. 4, the NAND map includes a complete list of LBAs of SSD 320, including whether each LBA stores valid memory (e.g., valid memory 220) or invalid memory (e.g., invalid memory 222).

FIG. 4 shows a NAND map 400 (e.g., a physical-to-logical mapping table), a list of physical locations 410 (e.g., including data indicative of invalid physical addresses of the memory), and a logical-to-physical mapping 420 (e.g., including valid physical addresses of the memory), in accordance with some embodiments of the present disclosure. The NAND map 400 may be generated by stitching together values from the list of physical locations 410 and values from the logical-to-physical mapping 420. In some embodiments, data collected using the approach of FIG. 3 is used to populate the list of physical locations 410 and the logical-to-physical mapping 420. Each of the NAND map 400, the list of physical locations 410, and the logical-to-physical mapping 420 may be any suitable size (e.g., corresponding to an SSD holding 4 TB, 8 TB, 16 TB, 30 TB, 61 TB, or any other suitable amount of memory).

Considering NAND map 400, though only data for Dies 1 and 2 are shown in FIG. 4, this is a truncated version of the map that is shown for ease of illustration. Indeed, NAND map 400 includes, for each die (i.e., Die 1 through Die M, where M is any suitable integer) of a memory array, the physical locations (“PL”) of the die and a logical status (i.e., a particular logical map “LM”, or an “Invalid” indicator) associated with memory stored at the corresponding physical location. In some embodiments, Die 1 through Die M represent the physical chips having the memory cells of SSD 320.

In one illustrative approach for generating NAND map 400, data is collected (e.g., using the operations at steps 304 and 306) to indicate whether each physical locations has valid or invalid data. Based on the data, the list of physical locations 410 is generated such that each physical location is flagged as containing invalid memory (e.g., invalid memory 222, as indicated by an ‘x’) or valid memory (e.g., valid memory 220, as indicated by a ‘✓’). Moreover, data is collected (e.g., using the operations at steps 304 and 306) to indicate the logical-to-physical mapping 420. As shown, the logical-to-physical mapping 420 may be arranged according to an ordering of the logical maps, which may differ from the ordering of the physical locations. For example, logical map 15 is stored at die 1, physical location 17, while subsequent logical map 16 is stored at die 2, physical location 10. Based on stitching together data of the list of physical locations 410 and data of the logical-to-physical mapping 420, NAND map 400 is generated. In particular, NAND map 400 may include an ordered list of physical locations, where each physical location has a corresponding indicator of invalid or valid memory, and if the physical location holds valid memory, then the indicator may be a logical map number.

With reference to the three-phase process described above for memory device preconditioning, generating the NAND map 400 (e.g., which may correspond to or be an aspect of generating the clone image) may correspond to the second phase.

As mentioned above, and as further shown and described in connection with FIGS. 5-7, NAND map 400 may be written onto a memory device (e.g., storage device 202 or SSD 520) to precondition the memory device for performance evaluations and/or functional testing.

FIG. 5 shows an approach for writing a clone image to a memory drive, in accordance with some embodiments of the present disclosure. In some embodiments, host 510 and SSD 520 respectively correspond to host 208 and storage device 202. Operations 502, 504, 506, 508, and 509 may be included within commands 220. With reference to the three-phase process described above for memory device preconditioning, the operations of FIG. 5 may correspond to the third phase.

At step 502, host 510 issues a command to turn on the vuSetFeature (i.e., where 0x01 is an indicator to activate this feature). The command at step 502 instantiates the clone image writing process (e.g., the NAND map writing process).

At step 504, the host 510 issues a series of 12 write commands (i.e., “Wr Cmd”) for an initial band (i.e., “Band0”) of the SSD 520. That is, host 510 causes SSD 520 to write data to Band0 (and LBAs of the band) of the SSD based on information of the LBA table (e.g., based on the list of physical locations and the corresponding memory indicators as provided in NAND map 400).

At step 506, host 510 repeats the operations at step 504 for all memory bands of SSD 520. That is, each respective series of read commands is repeated for each respective band, up to N bands, where N is the number of bands in the memory array of SSD 520.

In some embodiments, steps 504 and 506 each include using at least one host-initiated firmware hook and/or at least one vendor-specific command. Using this process, the host may read data from the NAND map and issue write commands, causing the SSD to write valid or invalid data at the target locations based on the data of the NAND map. Moreover, using this process maintains the integrity of NAND metadata (e.g., which may otherwise be described as memory metadata, and which is described at least in connection with step 509) during the writing process.

Based on steps 504 and 506, host 510 causes a NAND map 400 to be written to the entire memory array of SSD 520. In some embodiments, causing the NAND map to be written includes issuing the write commands of steps 504 and 506 without transferring any of the data that is written. For example, host 510 may cause SSD 520 to write valid placeholder data to physical locations with valid memory, and the host may cause the SSD to write invalid placeholder data to physical locations with invalid memory, without transferring any of the placeholder data. In some embodiments, host 510 also causes firmware of SSD 520 to randomly generate the valid and invalid placeholder data.

For each series of writes (e.g., as is associated with steps 504 and 506), the host 510 may cause the SSD 520 to write the data in a sequence that it creates the required invalid locations and the required valid locations. For example, for each respective band, the host 510 may cause the SSD 520 to create invalid location addresses by causing firmware of the SSD to write invalid placeholder data to the invalid physical addresses of the band (e.g., which may be a portion of all the invalid physical addresses), and after the invalid location addresses are created, the host 510 may cause the SSD to create valid location addresses by causing the firmware of the SSD to write valid placeholder data to the valid location addresses of the band (e.g., which may be a portion of all the valid physical addresses).

At step 508, host 510 issues a command to turn off the vuSetFeature (i.e., where 0x00 is an indicator to deactivate this feature). The command at step 508 may complete the NAND map writing process (e.g., which may correspond to or be an aspect of the clone image writing process). Despite being shown below step 508, the optional operations at step 510 may occur before the operation at step 508.

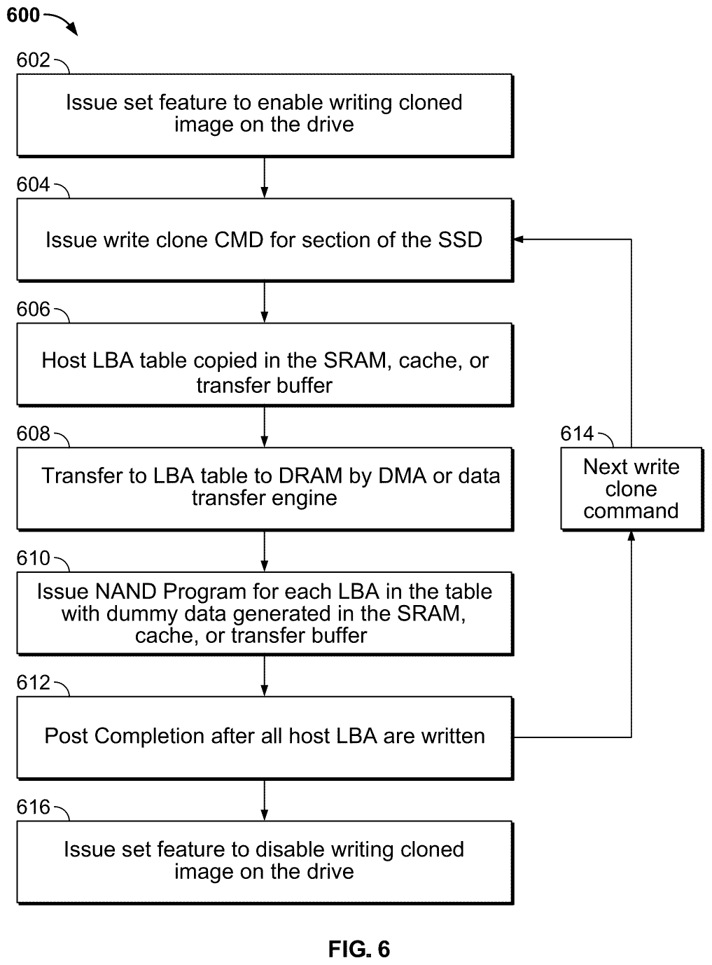

FIG. 6 shows a flowchart of illustrative steps for writing a clone image to a memory drive, in accordance with some embodiments of the present disclosure. In some embodiments, the method of FIG. 6 may correspond to the approach of FIG. 5. The method of FIG. 6 may be performed by a host device (e.g., host 208 or 510) at a storage device (e.g., storage device 202 or SSD 520).

At step 602, set features are issued to enable writing of a cloned image (e.g., a NAND map) on a drive (e.g., a memory array) of a storage device (e.g., an SSD). In some embodiments, the operations at step 602 corresponds to the operations at step 502.

At step 604, a write clone command (e.g., a NAND map write command) is issued for a section of the SSD. At step 606, a portion of a host LBA table (e.g., where the host LBA table may correspond to the NAND map 400) is copied from the host to the SSD. In particular, the host LBA table is copied to SRAM, cache memory, or transfer buffer memory of the SSD. At step 608, the host LBA table is transferred to DRAM of the SSD (e.g., using a direct memory access (DMA) protocol or any other suitable data transfer engine). At step 610, a NAND program command, which may also be described as a NAND write command, is issued (i.e., “Issue NAND program”) for each LBA in the portion of the host LBA table that was copied at step 606. Issuing the NAND program command includes causing the SSD to generate dummy data (i.e., placeholder data) at the SSD's SRAM, cache memory, or transfer buffer memory, and to write each portion of the dummy data to the corresponding DRAM LBA. At step 612, the SSD provides a completion notice (i.e., “post completion”) after all LBAs indicated by the host (i.e., “host LBA”) are written. At step 614, the host issues the next write clone command (e.g., to write to a next section or band of the SSD). Thus, steps 604 through 612 are repeated at this next section or band of the SSD. In some embodiments, steps 604 through 614 correspond to steps 504 and 506.

In some embodiments, firmware of the SSD maintains a status counter (e.g., in a log page) that tracks the progress of writing the NAND map. For example, the status counter may track which band or which LBA is being written to. This status counter can be made accessible to the host (e.g., for tracking progress of the preconditioning workload).

At step 616, set features are issued to disable writing of a cloned image (e.g., including the NAND map) on a drive (e.g., a memory array) of a storage device (e.g., an SSD). In some embodiments, the operations at step 616 corresponds to the operations at step 508.

With reference to the three-phase process described above for memory device preconditioning, the steps of FIG. 5 and/or the steps of FIG. 6 may correspond to the third phase.

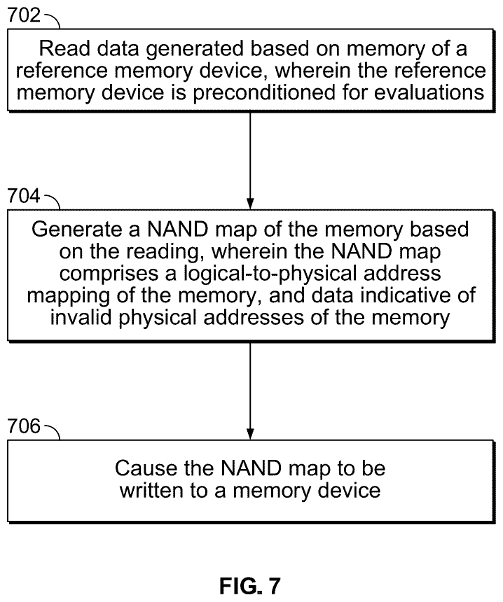

FIG. 7 shows a flowchart of illustrative steps of a method 700 for memory device preconditioning, in accordance with some embodiments of the present disclosure. In some embodiments, the method 700 is performed by one or more host device (e.g., host device 208, host 310, and/or host 510) on one or more storage device (e.g., storage device 202, SSD 320, and/or SSD 520).

In some embodiments, a first host device (e.g., that is communicatively coupled to a reference memory device) generates data based on memory of the reference memory device and, optionally, based on additional information of the reference memory device. Then, according to the steps of method 700, a second host device (e.g., that is communicatively coupled to the memory device that is being preconditioned) reads the data generated by the first host device and uses that data to precondition the corresponding memory device for evaluations.

At step 702, method 700 includes reading data generated based on memory of a reference memory device, where the reference memory device is preconditioned for evaluations (e.g., performance evaluations or functional testing). With reference to the three-phase process described above for memory device preconditioning, step 702 may correspond to the first phase. In some embodiments, step 702 corresponds to the operations of FIG. 3. In some embodiments, reading data generated based on memory of a reference device at step 702 may include reading the memory of the reference memory device.

At step 704, method 700 includes generating a NAND map (e.g., NAND map 400) of the memory based on the reading, where the NAND map includes a logical-to-physical address mapping (e.g., logical-to-physical mapping 420) and data indicative of invalid physical addresses of the memory (e.g., list of physical addresses 410). With reference to the three-phase process described above for memory device preconditioning, step 704 may correspond to the second phase.

At step 706, method 700 includes causing the NAND map to be written to a memory device (e.g., separate from the reference memory device). With reference to the three-phase process described above for memory device preconditioning, step 706 may correspond to the third phase. In some embodiments, step 706 corresponds to the operations of FIG. 5, FIG. 6, or both.

Thus it has been shown that systems and methods are provided for memory device preconditioning. While the systems and methods of the present disclosure are provided, in some embodiments, for preconditioning with respect to performance evaluations or functional testing, it will be understood that this disclosure may apply at least to any approach for sequential writing to a memory device.

The terms “an embodiment”, “embodiment”, “embodiments”, “the embodiment”, “the embodiments”, “one or more embodiments”, “some embodiments”, and “one embodiment” mean “one or more (but not all) embodiments”unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders.

In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for configuring a memory device, the method comprising:
reading, using a host device, data generated based on memory of a reference memory device, wherein the reference memory device is preconditioned for evaluations;
generating a NAND map of the memory based on the reading, wherein the NAND map comprises:
a logical-to-physical address mapping of the memory, and
data indicative of invalid physical addresses of the memory; and
causing the NAND map to be written to the memory device.

2. The method of claim 1, wherein the NAND map comprises physical-to-logical address mapping data indicative of:
valid physical addresses of the logical-to-physical address mapping, and
the invalid physical addresses.

3. The method of claim 2, wherein causing the NAND map to be written comprises:
causing firmware of the memory device to write the NAND map, wherein causing the firmware of the memory device to write the NAND map comprises:
creating invalid location addresses by writing invalid placeholder data to at least a portion of the invalid physical addresses, and
after writing to at least the portion of the invalid physical addresses, creating valid location addresses by writing valid placeholder data to at least a portion of the valid location addresses.

4. The method of claim 3, wherein causing the NAND map to be written comprises issuing a plurality of write commands without transferring the invalid placeholder data or the valid placeholder data.

5. The method of claim 4, further comprising causing firmware of the memory device to randomly generate data for the invalid placeholder data and for the valid placeholder data.

6. The method of claim 1, further comprising reading additional information of the memory, the additional information comprising at least one of: memory component temperatures or memory metadata.

7. The method of claim 6, wherein the memory metadata comprises at least one of an erase cycle count, a read disturb count, a program count, or a time since a memory location was last programmed.

8. The method of claim 6, further comprising, after causing the NAND map to be written to the memory, causing the additional information to be written to the memory.

9. A system comprising a host device communicatively coupled to a memory device, the host device to:
read data generated based on memory of a reference memory device, wherein the reference memory device is preconditioned for evaluations;
generate a NAND map of the memory based on the read, wherein the NAND map comprises:
a logical-to-physical address mapping of the memory, and
data indicative of invalid physical addresses of the memory; and
cause the NAND map to be written to the memory device.

10. The system of claim 9, wherein the NAND map comprises physical-to-logical address mapping data indicative of:
valid location addresses of the logical-to-physical address mapping table, and
the invalid physical addresses.

11. The system of claim 10, wherein to cause the NAND map to be written comprises:
causing firmware of the memory device to write the NAND map, wherein causing the firmware of the memory device to write the NAND map comprises:
creating invalid location addresses by writing invalid placeholder data to at least a portion of the invalid physical addresses, and
after writing to at least the portion of the invalid physical addresses, creating valid location addresses by writing valid placeholder data to at least a portion of the valid location addresses.

12. The system of claim 11, wherein to cause the NAND map to be written comprises issuing a plurality of write commands without transferring the invalid placeholder data or the valid placeholder data.

13. The system of claim 12, wherein the host device is further to cause firmware of the memory device to randomly generate the invalid placeholder data and the valid placeholder data.

14. The system of claim 9, wherein the host device is further to read data generated based on additional information of the memory, the additional information comprising at least one of:
memory component temperatures or memory metadata.

15. The system of claim 14, wherein the memory metadata comprises at least one of an erase cycle count, a read disturb count, a program count, or a time since a memory location was last programmed.

16. The system of claim 14, wherein the host device is further to, after causing the NAND map to be written to the memory, cause the additional information to be written to the memory.

17. A data structure for configuring memory of a memory device, the data structure comprising:
a logical-to-physical address mapping comprising valid physical addresses of the memory, wherein valid memory is stored at the valid physical addresses;
data indicative of invalid physical addresses of the memory, wherein invalid memory is stored at the invalid physical addresses; and
physical-to-logical address mapping data indicative of the valid physical addresses and the invalid physical addresses.

18. The data structure of claim 17, further comprising memory component temperatures of the memory device.

19. The data structure of claim 17, further comprising memory metadata of the memory device.

20. The data structure of claim 19, wherein the memory metadata comprises at least one of an erase cycle count, a read disturb count, or a program count.
